(19) United States
(12) Patent Application Publication
(10) Pub. No.: US 2005/0289353 A1
(43) Pub. Date: Dec. 29, 2005

(54) Non-intrusive trusted user interface

(76) Inventor: Mikael Dahlke, Trangsund (SE)

Correspondence Address: JENKENS & GILCHRIST, PC, 1445 ROSS AVENUE, SUITE 3200, DALLAS, TX, 75202, US

(21) Appl. No.: 10/876,045

(22) Filed: Jun. 24, 2004

(51) Int. Cl. H04K 1/00; H04L 9/00

(52) U.S. Cl. 713/182

(57) ABSTRACT

A method and system for indicating to a user whether the application is a trusted application. The trusted application accurately displays a secret code to a user and a non-trusted application does not accurately display the secret code to the user. This Abstract is provided to comply with rules requiring an Abstract that allows a searcher or other reader to quickly ascertain subject matter of the technical disclosure. This Abstract is submitted with the understanding that it will not be used to interpret or limit the scope or meaning of the claims.

### BACKGROUND OF THE INVENTION

1. Technical Field

The present invention relates to user interfaces, and more particularly, but not by way of limitation, to trusted user interfaces for applications seeking confidential information.

2. History of the Related Art

Various user applications are utilized in electronic devices, such as mobile telephones, PDAs, and laptops. Device applications may be granted access to various resources at installation. Access privileges may be based, for example, on a match between application digital signatures and digital certificates on the device.

When a user wishes to utilize a trusted application (i.e., to make a secure transaction), the user enters confidential information, such as a social security number, bank account number, or PIN number in the trusted application. A trusted application is a secure application that does not allow the confidential information to be viewed or copied by other applications. The information entered in the trusted application is utilized in the manner known by the user, e.g., the confidential information is not being stolen or copied to another location.

Criminals sometimes attempt to mimic applications in order to gain access to a user's confidential information. The act of mimicking applications is known as “spoofing” and typically entails copying the confidential information entered by a user and transmitting the copied information to the criminal. For example, a criminal may take screen shots of a trusted application and mimic the application so that the appearance, images, text, etc. of a spoofed application are very similar to that of the trusted application. The spoofed application may be unknowingly downloaded by the user, beamed to the user's device with, for example, infrared or BLUETOOTH technology, or installed on the user's device in other ways. When the user attempts to access the trusted application, the spoofed application is activated. The spoofed application stores the confidential information entered by the user and transmits the confidential information back to the criminal via infrared, Bluetooth, wireless Internet, etc.

A variety of technologies currently exist to prevent users from entering information in a spoofed application. For example, one current solution requires a visual indicator to alert the user that the application is a trusted application. An external indicator, such as an LED, may be utilized to indicate that the application is a trusted application. In another solution, a portion of the display may be reserved to indicate that the application is trusted. A symbol on a status bar, such as a padlock symbol, may be displayed to indicated when the application is a trusted application.

### BRIEF SUMMARY OF THE INVENTION

A method for initializing a mobile device of a user includes booting up an operating system of the mobile device, determining whether a current use of the mobile device is a first use of the mobile device, prompting the user for a secret code if it is determined that the current use is the first use of the mobile device, and storing the secret code in a memory of the mobile device.

A method of completing a secure transaction on a mobile device includes entering a secure transaction procedure on the mobile device, displaying, via an application, a screen for completion of the secure transaction, checking, via an operating system, capabilities of the application, determining, based on the checked capabilities, whether, access should be granted to the application, and aborting the transaction if it is determined that access should not be granted. If it is determined that access should be granted, a secret code, previously entered by a user, from a secure storage, is read, and the secret code is displayed to the user.

A device for informing a user whether an application is a trusted application includes an operating system for controlling operation of the device, an application for completing a secure transaction on the device, and a memory for storing a secret code entered by a user. The application properly displays the secret code if the application is a trusted application.

A method of completing a secure transaction using a mobile device of a user includes receiving, by the mobile device, of a secret code in a safe mode, storing the secret code in a memory of the mobile device, checking capabilities of an application used in connection with a secure transaction, and determining, based on the checked capabilities, whether access should be granted to the application. If it is determined that access should be granted, the secret code from the memory is read and the secret code is displayed to the user.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a block diagram of a mobile device utilized in accordance with an embodiment of the present invention;

FIG. 2 is a diagram of a screen shot of an application in accordance with an embodiment of the present invention;

FIG. 3 is a diagram of a screen shot of a spoofed application in accordance with an embodiment of the present invention;

FIG. 4 is a flow diagram of a method for initializing a system in accordance with an embodiment of the present invention; and

FIG. 5 is a flow diagram of a method for performing a secure transaction in accordance with an embodiment of the present invention.

### DETAILED DESCRIPTION OF THE INVENTION

A user of an application may be informed, via a secret code, that the application is trusted. Referring now to FIG. 1, a block diagram of a device 10 (e.g., a mobile telephone, PDA, laptop, etc. . . . ) is illustrated. The device 10 includes a trusted application 12, an operating system 14, a WIM 16, hardware 18, and physical memory 20. The hardware 18 may include, for example, processors, displays, memories, and input/output devices. The physical memory 20 is, for example, where code executes and data is stored.

The trusted application 12 may be stored on the device 10 prior to purchase of the device 10 or downloaded to the device 10 by the user at a later time. The operating system 14 controls operation of the device 10, including access to various device resources. The WIM 16 is a security module implemented in a SIM card for Wireless Application Protocol (WAP) applications. The WIM 16 provides security services for WAP applications and allows the use of digital signatures.

When the device 10 is purchased, or an application is loaded onto the device 10, a user may be prompted to enter a secret code. The secret code may be, for example, a series of numbers and/or letters, a word, phrase, or sentence that the user remembers or recognizes. The secret code should be entered in a setting where no foreign or non-trusted applications are present (i.e., in a safe mode of the device). Following entry, the secret code is stored in a secure memory. For example, the secret code may be stored in the WIM 16 or in other specialized hardware that is accessible using highest system permissions. In another option, the secret code may be encrypted and hidden in a portion of the physical memory 20 by the operating system 14.

The WIM 16 is included in a SIM card or implemented in software of the device 10, includes a cryptography engine, and may use digital certificates. When the trusted application 12 is installed, the trusted application 12 is assigned a code that allows the trusted application 12 to access the secret code. Spoofed applications do not have the code and therefore cannot locate and/or decrypt the secret code.

A software installer typically assigns capabilities to an application during installation of the application. The capabilities depend upon which digital certificate the application is signed against. The capabilities may be, for example, nothing (e.g., used for simple games), read user data (e.g., in order to protect user privacy), write user data (e.g., to protect the integrity of user private data), make phone call (incurs costs to the user), access a GPRS network (incurs costs to the user), system capability (e.g., do everything, highest capability), and access the trusted UI. Capabilities are stored in a safe place by the operating system 14. One example of an implementation would be to assign one bit in a data word per capability for every application on the device 10.

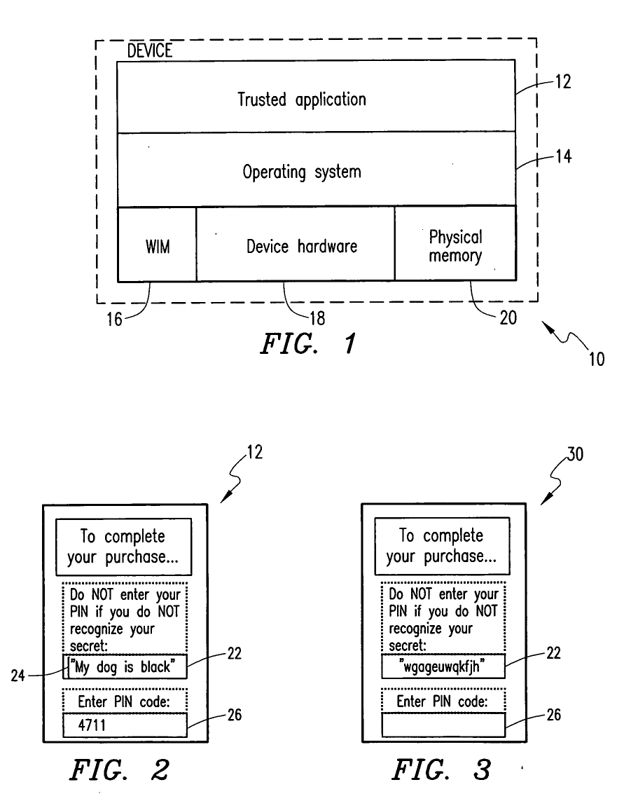

Referring now to FIGS. 2 and 3, screen shots of the trusted application 12 and a spoofed application are illustrated. When the user wishes to access the trusted application 12, a dialog box 22 is displayed with the secret code 24 shown therein. If the secret code 24 is properly displayed, then the application is deemed to be a trusted application 12. If the secret code 24 is incorrect, the application is deemed to be a spoofed application 30. For example, the spoofed application 30 may display nothing, or characters other than the secret code 24, in the dialog box 22. If, for example, the user wishes to make an online purchase, a confidential input box 26 may be displayed that requires the user to input confidential information, such as a PIN number. Although FIGS. 2 and 3 illustrate use of particular dialog boxes, text, instructions, images, etc. . . . . it will be understood by one skilled in the art that various dialog boxes, text, etc. . . . . may be presented to a user in any format that displays the secret code.

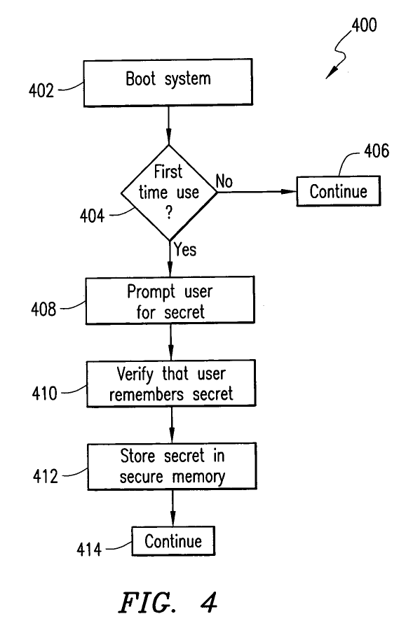

Referring now to FIG. 4, a method 400 of initializing the device 10 is illustrated. At step 402, the device 10 is booted up. For example, the device 10 may be powered on, or the operating system 14 may be restarted after downloading, for example, an application. At step 404, the device 10 determines if, after booting up, it is the first use of the device 10. If it is not the first use, then the device 10 proceeds to step 406 and continues operation as normally associated with the device 10. If it is the first use of the device 10, then, at step 408, the user is prompted to enter a secret code. At step 410, the user may be prompted to re-enter the secret code or affirm that the previously-entered secret code is correct. If so desired, step 410 may be eliminated. At step 412, the secret code is stored in a secure memory, such as the WIM 16 or encrypted memory, as noted above. At step 414, after the secret code is stored, the device 10 may continue operation in a manner similar to step 406.

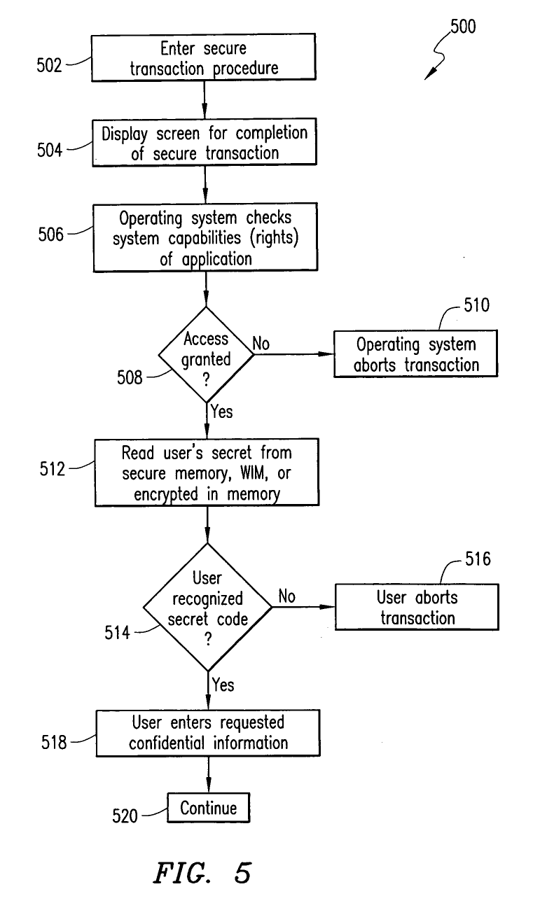

Referring now to FIG. 5, a method 500 of completing a secure transaction is illustrated. A secure transaction may involve, for example, making a purchase online, accessing banking or financial information, or accessing confidential information. At step 502, a secure transaction procedure is entered by the user. As noted above, the secure transaction procedure may be, for example, checking out to complete an online purchase. At step 504, a screen is displayed for the completion of the purchase by the user. For example, a display screen may include a warning regarding the secret code or a confidential input box for entering confidential information of the user. At step 506, the operating system determines the capabilities (i.e., rights) of the application. In other words, the operating system then determines whether the application has the capability to access the trusted UI by, for example, checking a corresponding memory location as described above. At step 508, based on the result of step 506, it is determined whether access should be granted to the application. If, at step 508, the application does not have the requisite capabilities, access is not granted. If, at step 508, it is determined that the application does have the requisite capabilities, access is granted.

If access is not granted at step 508, at step 510, the transaction is aborted by the operating system 14. If access is granted, at step 512, the user's secret code 24 is read from the secure memory and displayed in, for example, the dialog box 22. At step 514, it is determined whether the user has recognized the secret code 24. If the user did not recognize the secret code 24, the user may abort the transaction at step 516. If the user did recognize the secret code 24, the user may enter the requested confidential information at step 518 in order to complete the transaction. When the transaction is complete, the device 10 proceeds to step 520 and may continue normal operation (e.g., continue access to the Internet, answer/make wireless telephone calls, etc. . . . ).

It is thus believed that the operation and construction of various embodiments of the present invention are apparent from the foregoing Detailed Description. While various embodiments have been described, it will be obvious to a person of ordinary skill in the art that various changes and modifications may be made therein without departing from the spirit and scope of the invention, as defined in the following claims. Therefore the scope of the appended claims should not be limited to the description of the embodiments contained herein.

1. A method for initializing a mobile device of a user, the method comprising:
booting up an operating system of the mobile device;
determining whether a current use of the mobile device is a first use of the mobile device;
prompting the user for a secret code if it is determined that the current use is the first use of the mobile device; and
storing the secret code in a memory of the mobile device.

2. The method of claim 1, further comprising the step of verifying the secret code entered by the user.

3. The method of claim 2, wherein the step of verifying comprises the step of re-entering the secret code by the user.

4. The method of claim 1, wherein the step of booting up comprises the step of powering on the mobile device.

5. The method of claim 1, wherein the step of storing comprises storing the secret code in a Wireless Identity Module (WIM) of the mobile device.

6. The method of claim 1, wherein the step of storing comprises:
encrypting the secret code; and
storing the encrypted secret code in the memory.

7. The method of claim 1, wherein the step of storing comprises storing the secret code in a secure memory.

8. A method of completing a secure transaction on a mobile device, the method comprising:
entering a secure transaction procedure on the mobile device;
displaying, via an application, a screen for completion of the secure transaction;
checking, via an operating system, capabilities of the application;
determining, based on the checked capabilities, whether, access should be granted to the application;
aborting the transaction if it is determined that access should not be granted; and
if it is determined that access should be granted:
reading a secret code, previously entered by a user, from a secure storage; and
displaying the secret code to the user.

9. The method of claim 8, further comprising aborting the transaction if a proper secret code is not displayed to the user.

10. The method of claim 8, further comprising allowing the user to enter confidential information if a proper secret code is displayed to the user.

11. A device for informing a user whether an application is a trusted application, the device comprising:
an operating system for controlling operation of the device;
an application for completing a secure transaction on the device;
a memory for storing a secret code entered by a user; and
wherein the application properly displays the secret code if the application is a trusted application.

12. The device of claim 11, wherein the device is operable as at least one of a mobile telephone, a personal digital assistant, and a laptop computer.

13. The device of claim 11, wherein the secure memory is operable as a Wireless Identity Module (WIM).

14. The device of claim 11, wherein the application may be downloaded to the device at any time.

15. The device of claim 11, wherein the application is installed on the device prior to purchase of the device by the user.

16. The device of claim 11, wherein the application includes means for displaying the secret code to the user.

17. The device of claim 11, wherein the memory is a secure memory.

18. The device of claim 11, wherein the secret code is encrypted.

19. A method of completing a secure transaction using a mobile device of a user,
the method comprising:
receiving, by the mobile device, of a secret code in a safe mode;
storing the secret code in a memory of the mobile device;
checking capabilities of an application used in connection with a secure transaction;
determining, based on the checked capabilities, whether access should be granted to the application; and
if it is determined that access should be granted:
reading the secret code from the memory; and
displaying the secret code to the user.

20. The method of claim 19, further comprising aborting the transaction if a proper secret code is not displayed to the user.

21. The method of claim 19, further comprising allowing the user to enter confidential information if a proper secret code is displayed to the user.

22. The method of claim 19, wherein the step of storing comprises encrypting the secret code.

23. The method of claim 19, wherein the step of storing comprises:
encrypting the secret code; and
storing the encrypted secret code in the memory.

24. The method of claim 19, wherein the memory is a secure memory.
